(19) United States
(12) Patent Application Publication
(10) Pub. No.: US 2024/0019550 A1
(43) Pub. Date: Jan. 18, 2024

(54) SCANNING LIGHT SOURCE WITHOUT MOVING PARTS

(71) Applicant: Robert Bosch GmbH, Stuttgart (DE)

(72) Inventor: Michael T. White, Livonia, MI (US)

(21) Appl. No.: 17/864,186

(22) Filed: Jul. 13, 2022

(51) Int. Cl. G01S 7/481; G01S 17/42; G01S 17/894

(52) U.S. Cl. CPC G01S 7/4817; G01S 17/42; G01S 17/894; G01S 7/4815

(57) ABSTRACT

A light source capable of scanning the field of view (FOV) thereof without employing moving parts. In an example embodiment, the light source includes an addressable array of semiconductor lasers provided with an optical FOV adaptor in which optical fibers are spatially arranged in a fanout configuration to provide suitable sampling spots within a relatively large FOV suitable for lidar-based or structured-light-based depth mapping. For example, by selectively firing different individual lasers of the laser array at different times in a raster pattern, the light source can effectively optically scan the FOV in a manner suitable for lidar applications. Different optical FOV adaptors can beneficially be used to enable the same laser array to optimally sample differently shaped FOVs typically encountered in different specific applications. Due to the non-mechanical scanning structure thereof, the laser source is well suited for mobile-platform applications, such as autonomous driving.

### BACKGROUND

### Field

Various examples relate to light sources and, more specifically but not exclusively, to light sources for lidar transmitters.

### Description of the Related Art

This section introduces aspects that may help facilitate a better understanding of the disclosure. Accordingly, the statements of this section are to be read in this light and are not to be understood as admissions about what is in the prior art or what is not in the prior art.

Light detection and ranging, known as lidar, is a remote-sensing technique that can be used to measure a variety of parameters, such as distance, velocity, and vibration, and also for high-resolution imaging. Compared to radio-frequency (RF) remote sensing, lidar is capable of providing a finer range resolution and a higher spatial resolution due to the use of a higher carrier frequency and the ability to generate a smaller spot size at the foci. Lidar systems are used in urban planning, hydraulic and hydrologic modeling, geology, forestry, fisheries and wildlife management, three-dimensional (3D) imaging, engineering, coastal management, atmospheric science, meteorology, navigation, autonomous driving, robotic and drone operations, and other applications.

### BRIEF SUMMARY

Disclosed herein are, among other things, various aspects, features, and embodiments of a light source capable of scanning the field of view (FOV) thereof without employing moving parts. In an example, the light source includes an addressable two-dimensional (2D) array of semiconductor lasers provided with a monolithic optical adaptor in which optical fibers or waveguides are spatially arranged in a fanout configuration to provide suitable sampling spots within a relatively large FOV suitable for lidar-based or structured-light-based 3D mapping. For example, by selectively firing different individual lasers of the laser array at different times in a raster pattern, the light source can effectively optically scan the FOV in a manner suitable for 3D mapping. Different optical adaptors can beneficially be used to enable substantially the same laser array to optimally sample differently shaped FOVs typically encountered in different specific applications. Due to the non-mechanical scanning structure thereof, the laser source is well suited for mobile-platform applications, such as autonomous driving.

One example provides an apparatus that includes an array of lasers disposed along a substantially planar substrate. The apparatus further includes an optical adapter having a first surface and an opposite second surface. The first surface is adjacent and along the array of lasers. The optical adapter includes a plurality of optical waveguides, each of the optical waveguides having a respective first end at the first surface and a respective second end at the second surface. The plurality of optical waveguides is optically end-connected to the array of lasers. An end section of a first optical waveguide of the plurality of optical waveguides is oriented at a first nonzero angle with respect to a surface normal of the second surface. The end section of the first optical waveguide is adjacent to the respective second end thereof. An end section of a second optical waveguide of the plurality of optical waveguides is oriented at a different second nonzero angle with respect to the surface normal. The end section of the second optical waveguide is adjacent to the respective second end thereof.

Another example provides an optical method that includes the steps of: determining, via an electronic controller, a next laser to emit light in an array of lasers; routing, via a driver circuit, one or more firing voltages to the next laser to cause the next laser to emit an optical pulse through a respective set of one or more optical waveguides of an optical adapter having a first surface and an opposite second surface, the first surface being adjacent and along the array of lasers; and repeating the steps of determining and routing to cause different ones of the lasers in the array of lasers to emit respective optical pulses at different respective times. The optical adapter includes a plurality of the optical waveguides and each of the optical waveguides has a respective first end at the first surface of the optical adapter and a respective second end at the second surface of the optical adapter. The plurality of optical waveguides is optically end-connected to the array of lasers. An end section of a first optical waveguide of the plurality of optical waveguides is oriented at a first nonzero angle with respect to a surface normal of the second surface, the end section of the first optical waveguide being adjacent to the respective second end thereof. An end section of a second optical waveguide of the plurality of optical waveguides is oriented at a different second nonzero angle with respect to the surface normal, and the end section of the second optical waveguide is adjacent to the respective second end thereof.

### BRIEF DESCRIPTION OF THE DRAWINGS

Other aspects, features, embodiments, and benefits will become more fully apparent, by way of example, from the following detailed description and the accompanying drawings, in which:

FIG. 1 is a block diagram illustrating a lidar environment, including a lidar system in which various embodiments may be practiced.

FIG. 2 is a schematic cross-sectional side view illustrating a light source that is used in the lidar system of FIG. 1 according to some examples.

FIG. 3 pictorially illustrates the field of view of the lidar system of FIG. 1 according to some examples.

FIG. 4 is a plan view illustrating a laser array that is used in the light source of FIG. 2 according to some examples.

FIG. 5 is a plan view illustrating a laser array that is used in the light source of FIG. 2 according to other examples.

FIG. 6 is a plan view illustrating the laser source of FIG. 2 according to some examples.

FIG. 7 is a plan view illustrating the laser source of FIG. 2 according to other examples.

FIG. 8 is a plan view illustrating the laser source of FIG. 2 according to yet other examples.

FIG. 9 is a flowchart illustrating a method of operating the laser source of FIG. 2 according to some examples.

### DETAILED DESCRIPTION

In the following description, numerous details are set forth, such as optical device configurations, timings, operations, and the like, in order to provide an understanding of one or more aspects of the present disclosure. It will be readily apparent to a person of ordinary skill in the pertinent art that these specific details are merely examples and not intended to limit the scope of this application.

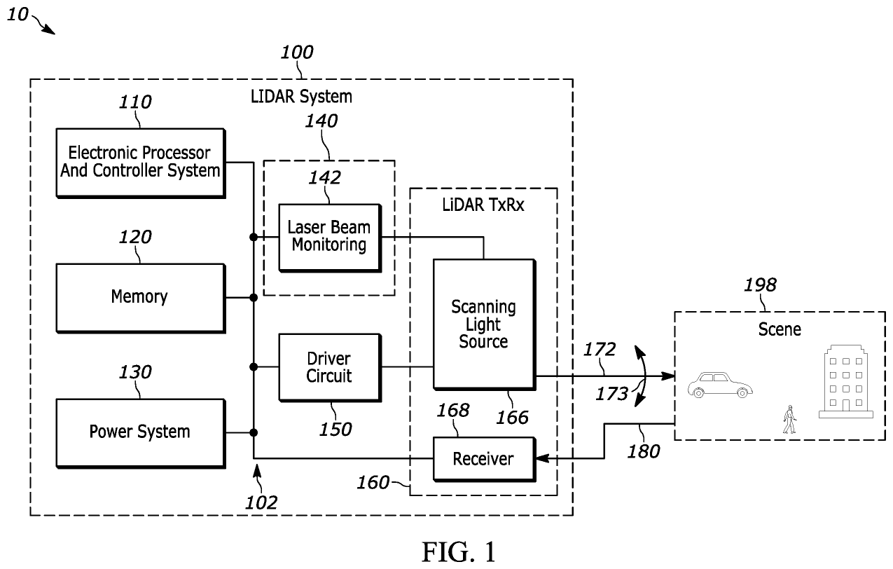

FIG. 1 is a block diagram illustrating a lidar environment 10 according to various embodiments. In the shown example, the lidar environment 10 includes a lidar system 100 and a scene 198. The lidar system 100 comprises an electronic controller 110, a memory 120, a power system 130, an optical monitor 140, a driver circuit 150, and a lidar transceiver (TxRx) 160. The electronic controller 110 typically includes a processor. In different embodiments, the lidar system 100 may include more or fewer components/elements compared to the number of components/elements explicitly shown in FIG. 1. For example, the lidar transceiver 160 may include various optical elements, such lenses, mirrors, optical adapters, and the like (not explicitly shown in FIG. 1). Also, the lidar system 100 may perform additional functions compared to the functionality described herein below. In some examples, some of the functionality of the lidar system 100 may be at least partly incorporated into a server or other electronic devices (not explicitly shown in FIG. 1) connected thereto. As illustrated in FIG. 1, different components of the lidar system 100 are electrically connected to each other via one or more control and/or data buses 102 to enable communications between said different components.

The lidar transceiver 160 comprises a scanning light (e.g., laser) source 166 and an optical receiver 168. The laser source 166 operates to generate an optical-probe beam 172 that is directed toward the scene 198. Depending on the intended application, the lidar system 100 may have one or more lenses (not explicitly shown in FIG. 1) arranged to form an optical collimator, an objective, and/or a telescope. A corresponding optical signal 180 generated by reflections of the optical-probe beam 172 from the scene 198 is captured by the lens system of the lidar transceiver 160 and applied to the optical receiver 168. The optical receiver 168 operates to convert the received optical signal 180 into electrical form and applies the resulting electrical signal to a processor, e.g., 110, for processing. The laser source 166 operates to optically scan the scene 198 by moving the light spot of the optical-probe beam 172 across the scene 198 within the field of view (FOV) of the lidar transceiver 160, e.g., as schematically indicated in FIG. 1 by a double-headed arrow 173. Depending on the example, the optical-probe beam 172 may be in the form of a continuous-wave (CW) optical beam or a pulsed optical beam. The optical-probe beam 172 may have a fixed carrier frequency or may be frequency-chirped. The carrier frequency can be in the ultraviolet, visible, near infrared, or infrared part of the optical spectrum.

In some examples, the laser source 166 and the optical receiver 168 are implemented in the form of two physically separate and distinct system elements. In some other examples, the laser source 166 and the optical receiver 168 are integrated into a single component or device, e.g., an opto-electronic chip or assembly. In such instances, the driver circuit 150 may be configured to provide appropriate electrical currents and/or voltages to pertinent integrated circuit components of both the laser source 166 and the optical receiver 168.

In one example, the optical monitor 140 includes a laser-beam monitor 142 configured to measure the intensity (optical power) and other pertinent characteristics of the optical-probe beam 172. The measurement/monitoring results generated by the optical monitor 140 are directed, via the bus 102, to the processor/controller 110 and are processed therein to monitor the optical performance of the lidar transceiver 160 and, if needed, to implement configuration changes directed at maintaining the intended level of performance for the lidar system 100.

In a typical conventional lidar system, the scanning light source includes an opto-mechanical scanner in which a mechanically movable mirror or other mechanically movable optical element is used to scan the optical-probe beam across the FOV. In mobile lidar applications in which the corresponding lidar system is mounted on a moving platform, such as a moving car, the scanning light source is typically subjected to relatively strong mechanical vibrations and/or shocks caused by the movement of the platform. Such mechanical vibrations and/or shocks may typically cause an opto-mechanical scanner to break down in a relatively short period of time, e.g., a time period that is shorter than an average lifespan of the corresponding vehicle, thereby disadvantageously requiring the lidar system repair or replacement.

The above-indicated problems in the state of the art can beneficially be addressed using at least some instances disclosed herein. More specifically, in one example, the laser source 166 is capable of optically scanning the FOV of the lidar system 100 without moving parts by employing an addressable 2D laser array coupled to an optical FOV adaptor in which optical fibers or waveguides are spatially arranged to provide suitable sampling points within the FOV. By selectively firing different lasers of the laser array, different points of the FOV can be sampled at different times, thereby providing the requisite FOV-scanning capability without employing moving parts. Due to the non-mechanical scanning structure thereof, the laser source 166 can be engineered to beneficially withstand mechanical vibrations/shocks for a longer period of time than a functionally comparable opto-mechanical scanner, without breaking down. In addition, at least some embodiments of the laser source 166 may be cheaper to manufacture than the functionally comparable opto-mechanical scanners.

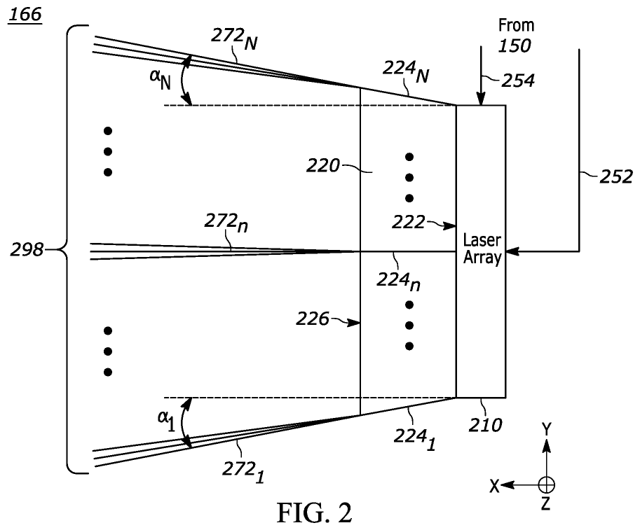

FIG. 2 is a schematic cross-sectional side view illustrating the light source 166 according to some examples. The XYZ-coordinate triad shown in FIG. 2 indicates the orientation of the shown cross-section as being parallel to the XY-coordinate plane. The light source 166 comprises a laser array 210 and an optical FOV adapter 220 stacked in the X-coordinate direction as indicated in FIG. 2.

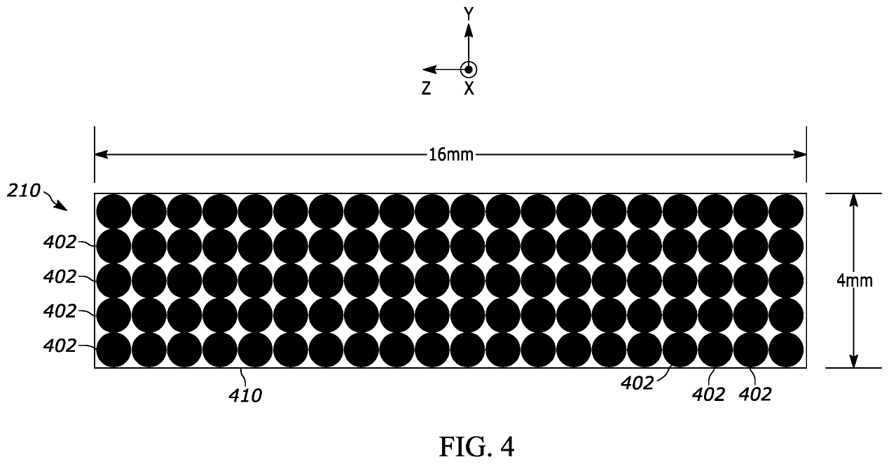

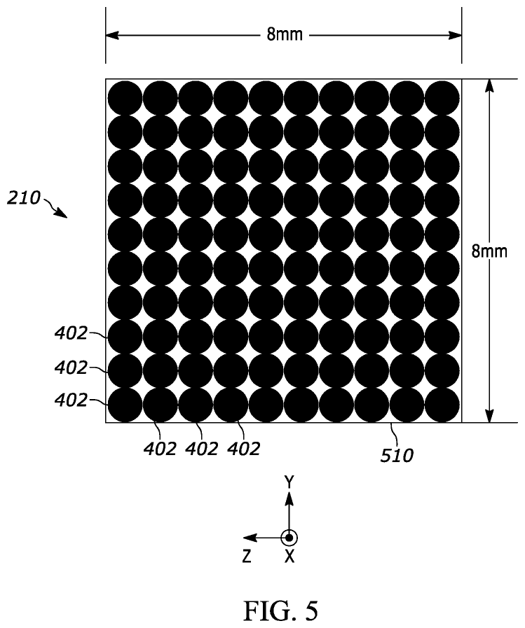

In an example embodiment, the laser array 210 is a substantially planar semiconductor device whose main plain is oriented parallel to the YZ-coordinate plane. Disposed along said main plane is a plurality of semiconductor lasers (not explicitly shown in FIG. 2; e.g., see FIGS. 4-5), each of which is configured to emit light in the direction that is substantially normal to the main plain, i.e., parallel to the X-coordinate axis. Depending on the embodiment, the plurality of semiconductor lasers of the laser array 210 may be arranged in a 2D (e.g., planar) array or in one-dimensional (e.g., linear) array.

Herein, a “main plane” of an object, such as a die, a substrate, an integrated circuit (IC), or a printed circuit board (PCB) is a plane parallel to a substantially planar surface thereof that has about the largest area among exterior surfaces of the object. This substantially planar surface may be referred to as a main surface. The exterior surfaces of the object that have one relatively large size, e.g., length, but are of much smaller area, e.g., less than one quarter of the main-surface area, are typically referred to as the edges of the object.

To cause an individual one of the semiconductor lasers of the laser array 210 to emit light, that individual semiconductor laser is appropriately electrically biased and injected with electrical current. One or more electrical signals 252 generated by the driver circuit 150 are appropriately routed to different semiconductor lasers of the laser array 210 for this purpose. Such routing can be implemented, e.g., using circuitry similar to that used in display devices or in solid state memories. The routing of the one or more electrical signals 252 is controlled using one or more address-control signals 254 generated by the driver circuit 150 in response to the corresponding control input received from the controller 110. For example, the one or more address-control signals 254 are used to control the states of switches via which individual ones of the semiconductor lasers of the laser array 210 are connected to or disconnected from the electrical lines supplying the one or more electrical signals 252.

In operation, at a given time, the one or more address-control signals 254 are used to select for emission: (i) a single one of the semiconductor lasers of the laser array 210; (ii) a subset of two or more semiconductor lasers of the laser array 210; or (iii) all of the semiconductor lasers of the laser array 210. Depending on the injection-current waveform, the light emitted by the selected semiconductor laser(s) of the laser array 210 is pulsed light or (quasi) CW light. The one or more address-control signals 254 are changed from time to time to change the selected subset of the semiconductor lasers in the laser array 210.

The FOV adapter 220 comprises a plurality of optical waveguides (e.g., optical fibers) 224, each being end-connected between a first surface 222 of the FOV adapter and an opposite second surface 226 of the FOV adapter. In one instance, the first and second surfaces 222, 226 of the FOV adapter 220 are substantially planar surfaces. The first surface 222 may be parallel to the second surface 226. The surfaces 222 and 226 of the FOV adapter 220 may also be parallel to the main plane (YZ in FIG. 2) of the laser array 210. In some other instances, such parallelism may not be a present, and deviations therefrom may be acceptable or even desirable. In some instances, at least the second surface 226 may be curved and/or have a plurality of micro-lenses attached thereto.

For clarity, only three of the optical waveguides 224 (labeled 224₁, 224n, and 224_{N}, respectively) of the FOV adapter 220, are explicitly shown in FIG. 2. The optical waveguides 224₁ and 224_{N} are located near the opposite edges of the FOV adapter 220. The optical waveguide 224n is located in a middle portion of the FOV adapter 220. In one example, the FOV adapter 220 may have a similar waveguide structure extending along the Z-coordinate axis. For example, a cross-section of the FOV adapter 220 taken parallel to the XZ-coordinate plane may generally be similar to the cross-section shown in FIG. 2. The total number of optical waveguides 224 in the FOV adapter 220 depends on the specific instance and are in the range, e.g., between 10 and 10⁴.

The end of an individual optical waveguide 224 located at the first surface 222 of the FOV adapter 220 is optically end-connected to receive light from a corresponding one of the semiconductor lasers of the laser array 210. In operation, the individual optical waveguide 224 guides the received light to the other end thereof located at the second surface 226 of the FOV adapter 220. The guided light then exits through that end of the optical waveguide 224, is collimated, and directed towards the directionally corresponding portion of an FOV 298. Depending on the specific configuration, a single optical waveguide 224 or a bundle of optical waveguides 224 are optically end-connected to receive light from a respective one of the semiconductor lasers of the laser array 210. In various examples, the number of optical waveguides 224 in such a bundle can range, e.g., from 2 to 100, or be even more than 100. In some examples, some or all of the optical waveguides 224 may be tapered such that the transverse size (e.g., the diameter) of the optical waveguide 224 is larger at the second surface 226 than at the first surface 222 of the FOV adapter 220.

End sections of different optical waveguides 224 located at the second surface 226 of the FOV adapter 220 may have different angles with respect to that surface. As an example, FIG. 2 illustrates an example in which: (i) the end section of the optical waveguide 224₁ has a nonzero angle α₁ with respect to the surface normal of the second surface 226; (ii) the end section of the optical waveguide 224ₙ is orthogonal to the second surface 226; and (iii) the end section of the optical waveguide 224_{N} has a nonzero angle cu with respect to the surface normal of the second surface 226. For the optical waveguides located between the optical waveguides 224₁ and 224ₙ, the angle gradually decreases, in equal or unequal increments, from the nonzero angle α₁ to the zero angle, as the position of the optical waveguide 224 gets farther from the corresponding edge and closer to the middle of the FOV adapter 220. Similarly, for the optical waveguides located between the optical waveguides 224_{N} and 224ₙ, the angle gradually decreases, in equal or unequal increments, from the nonzero angle α_{N} to the zero angle, as the position of the optical waveguide 224 gets farther from the corresponding edge and closer to the middle of the FOV adapter 220. In various examples, the angles α₁ and α_{N} may be the same or different. For example, in one instance, α₁=α_{N}=10°. In such an instance, the angular span of the FOV 298 in the XY-coordinate plane is 20 degrees. The angular span of the FOV 298 in the XZ-coordinate plane can be, e.g., in the range between approximately 5 degrees and approximately 10 degrees. At least some examples of the FOV adapter 220 is fabricated using 3D printing.

The light emitted from the end of the optical waveguide 224₁ is collimated to form an optical-probe beam 272₁ near a boundary of the FOV 298. The optical axis of the optical-probe beam 272₁ is oriented approximately at the same angle α₁ with respect to the surface normal of the second surface 226 as the end section of the optical waveguide 224₁. The optical-probe beam 272₁ propagates towards the corresponding scene 198 in the FOV 298, illuminates a spot on a surface of an object within the scene, and undergoes specular and/or diffuse reflection thereat to form a corresponding reflected optical beam 180 (also see FIG. 1), which propagates back to the lidar system 100 and is received therein by the optical receiver 168. The light emitted from the end of the optical waveguide 224ₙ is collimated to form an optical-probe beam 272ₙ in the middle of the FOV 298. The optical axis of the optical-probe beam 272ₙ is approximately orthogonal to the second surface 226. The optical-probe beam 272ₙ propagates towards the scene 198 in the FOV 298, illuminates a different respective spot on a surface of the same or different object within the scene, and undergoes specular and/or diffuse reflection thereat to form a corresponding reflected optical beam 180, which again propagates back to the lidar system 100 and is received therein by the optical receiver 168. The light emitted from the end of the optical waveguide 224_{N} is collimated to form an optical-probe beam 272_{N} near another boundary of the FOV 298. The optical axis of the optical-probe beam 272_{N} is oriented approximately at the same angle α_{N} with respect to the surface normal of the second surface 226 as the end section of the optical waveguide 224_{N}. The optical-probe beam 272_{N} propagates towards the scene 198 in the FOV 298, illuminates yet another spot on a surface of the same or different object within the scene, and undergoes specular and/or diffuse reflection thereat to form a corresponding reflected optical beam 180, which again propagates back to the lidar system 100 and is received therein by the optical receiver 168. Other (not explicitly shown in FIG. 2) optical waveguides 224 similarly produce respective optical-probe beams 272, which are reflected from the scene and received by the optical receiver 168.

In various alternatives, other angular arrangements of the optical waveguides 224 in the FOV adapter 220 are also possible. For example, in one possible example, the optical waveguides 224₁, 224ₙ, and 224_{N} may be oriented as follows: (i) the end section of the optical waveguide 224₁ is orthogonal to the second surface 226; (ii) the end section of the optical waveguide 224 has a nonzero angle αₙ with respect to the surface normal of the second surface 226; and (iii) the end section of the optical waveguide 224_{N} has a larger nonzero angle α_{N} with respect to the surface normal of the second surface 226, i.e., α₁=0 and α_{N}>αₙ>0. For the optical waveguides located between the optical waveguides 224₁ and 224_{N}, the tilt angle gradually increases, in equal or unequal increments, from the zero angle α1 to progressively larger angles, as the position of the optical waveguide 224 gets farther from the first edge and closer to the second edge of the FOV adapter 220.

In some alternatives, two or more light sources 166 are mounted side to side to increase the effective angular span of the FOV 298. The increase can be implemented for the lateral angular span only, for the vertical angular span only, or both for the lateral and vertical angular spans. The relative orientation of the two or more light sources 166 can be such that the FOVs of the individual light sources 166 partially overlap or are adjacent to one another without spatially overlapping.

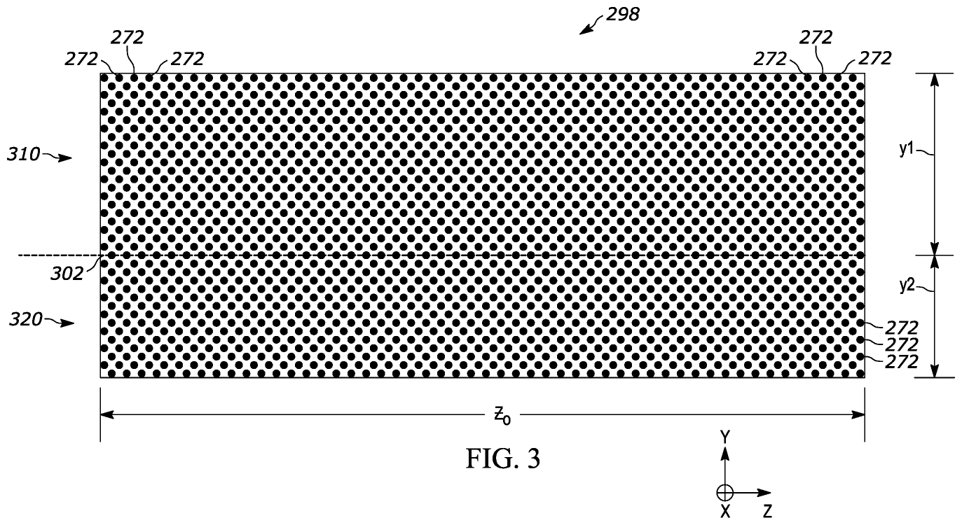

FIG. 3 illustrates the FOV 298 according to some examples. The XYZ-coordinate triad shown in FIG. 3 has the same orientation as the XYZ-coordinate triad of FIG. 2 to indicate the spatial relationship between the views shown in FIGS. 2 and 3. In the shown example, the FOV 298 has a generally rectangular shape with an aspect ratio of 2:5. In other examples, the FOV 298 can have other geometric shapes and/or aspect ratios.

Each spot within the shown FOV 298 represents a respective one of the optical-probe beams 272 (also see FIG. 2). The total number of optical-probe beams 272 within the shown FOV 298 is 810. These optical-probe beams 272 are arranged in a 2D array having the size of 18×45. In FIG. 3, a dashed line 302 indicates the division line between two rectangular portions (labeled 310 and 320) of the FOV 298. The portions 310 and 320 have the same width zo but different respective heights, labeled y₁ and y₂, respectively, where y₁>y₂. The number of optical-probe beams 272 per unit height in the portion 320 is larger than the number of optical-probe beams 272 per unit height in the portion 310. This example arrangement of optical-probe beams 272 is achieved by using the FOV adapter 220 in which the angle increment between different rows of the optical waveguides is not constant and has a larger (e.g., fixed) value in the part of the FOV adapter 220 corresponding to the portion 310 of the FOV 298 while having a smaller (e.g., fixed) value in the part of the FOV adapter 220 corresponding to the portion 320 of the FOV 298.

FIG. 4 is a plan view illustrating the laser array 210 according to some examples. The XYZ-coordinate triad shown in FIG. 4 has the same orientation as the XYZ-coordinate triad of FIG. 2 to indicate the spatial relationship between the views of FIGS. 2 and 4. In this example, the laser array 210 has one hundred individual semiconductor lasers 402 arranged along a substantially planar main surface of a substrate 410 in a 2D rectangular array, wherein the semiconductor lasers 402 are arranged in five rows and twenty columns. Each of the semiconductor lasers 402 has an approximately circular light-emitting area and is implemented, e.g., using a vertical cavity surface-emitting laser (VCSEL). In operation, a VCSEL 402 emits light in the direction that is substantially orthogonal to the main plain of the substrate 410, i.e., along the X-coordinate axis. For illustration purposes and without any implied limitations, example dimensions of the substrate 410 are also indicated in FIG. 4.

FIG. 5 is a plan view illustrating the laser array 210 according to other examples. The XYZ-coordinate triad shown in FIG. 5 has the same orientation as the XYZ-coordinate triad of FIG. 2 to indicate the spatial relationship between the views of FIGS. 2 and 5. In this example, the laser array 210 also has one hundred individual semiconductor lasers 402 arranged along a substantially planar main surface of a substrate 510 in a square 10×10 array. For illustration purposes and without any implied limitations, example dimensions of the substrate 510 are also indicated in FIG. 5. In various alternatives, the laser array 210 may have a different (from 100) number of semiconductor lasers 402, which may be arranged in a 2D array having any suitable geometric shape.

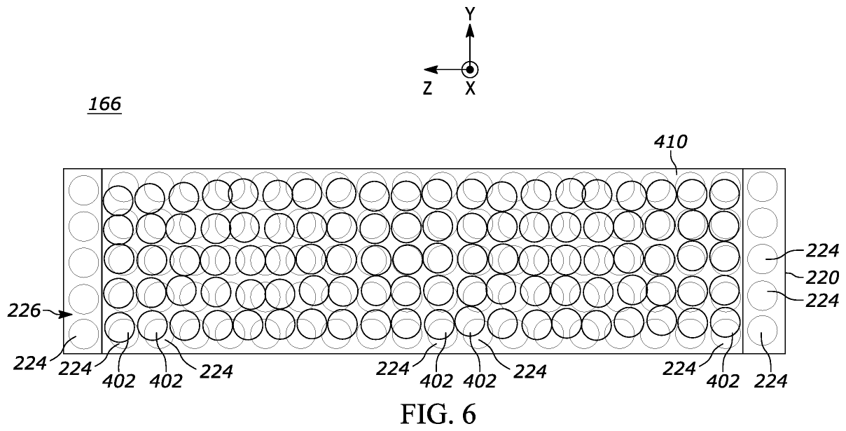

FIG. 6 is a schematic plan view illustrating the light source 166 according to some examples. The XYZ-coordinate triad shown in FIG. 6 has the same orientation as the XYZ-coordinate triad of FIG. 2 to indicate the spatial relationship between the views of FIGS. 2 and 6. In the example of FIG. 6, the light source 166 has the laser array 210 illustrated in FIG. 4. As described above in reference to FIG. 4, that laser array 210 has one hundred semiconductor lasers 402 arranged along the substrate 410 in a rectangular array. Attached to the laser array 210 is the FOV adapter 220 having one hundred optical waveguides 224. As a consequence, the laser source 166 of FIG. 6 has a one-to-one ratio of the optical waveguides 224 to the semiconductor lasers 402.

As can be seen in FIG. 6, the second surface 226 of the FOV adapter 220 has a larger area than the area of the substrate 410 occupied by the lasers 402. In some examples, the footprint of the FOV adapter 220 on the YZ plane is larger than the footprint of the laser array 210. In the view of FIG. 6, the first surface 222 of the FOV adapter 220 is not directly visible (also see FIG. 2). The ends of the optical waveguides 224 located at the first surface 222 are arranged to be substantially aligned with the corresponding individual semiconductor lasers 402. The corresponding end sections of the optical waveguides 224 located at the first surface 222 may be orthogonal thereto. As already indicated above, the optical waveguides 224 thereafter fan out at various angles thereby causing the ends of most of the optical waveguides 224 located at the second surface 226 to be laterally offset from the vertical projections of the corresponding individual semiconductor lasers 402 onto the second surface 226 as can be seen in FIG. 6. Herein, the term “vertical” means orthogonal to the second surface 226 of the FOV adapter 220 and/or to the main plane of the substrate 410. The term “lateral” means orthogonal to the vertical direction.

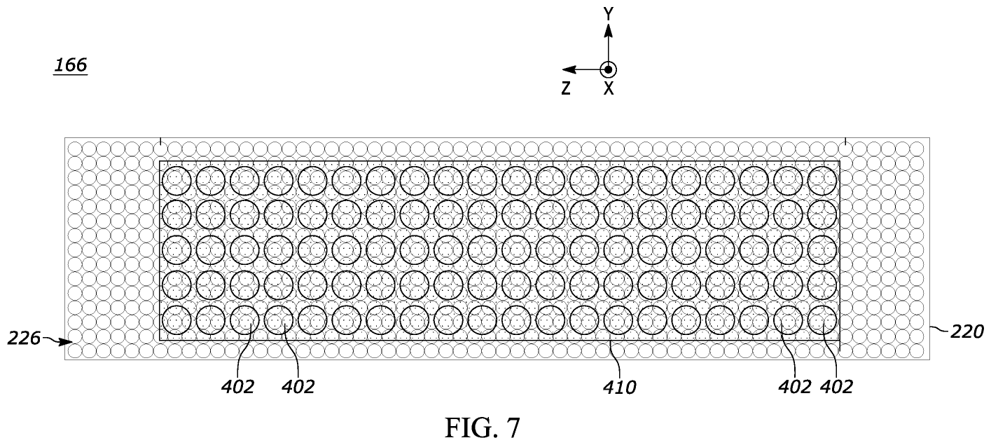

FIG. 7 is a schematic plan view illustrating the laser source 166 according to other examples. The XYZ-coordinate triad shown in FIG. 7 has the same orientation as the XYZ-coordinate triad of FIG. 2 to indicate the spatial relationship between the views of FIGS. 2 and 7. In the example of FIG. 7, the laser source 166 has the laser array 210 illustrated in FIG. 4. As described above in reference to FIG. 4, that laser array 210 has one hundred semiconductor lasers 402 arranged along the substrate 410 in a rectangular array. Attached to the laser array 210 is the FOV adapter 220 having nine hundred optical waveguides 224. As a consequence, the laser source 166 of FIG. 7 has a nine-to-one ratio of the optical waveguides 224 to the semiconductor lasers 402. The surface area of the second surface 226 is larger than the surface area of the substrate 410 occupied by the lasers 402.

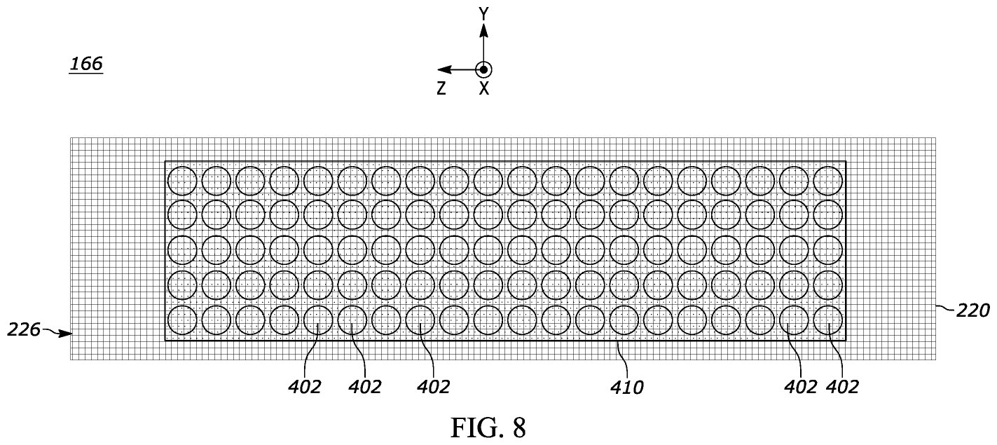

FIG. 8 is a schematic plan view illustrating the laser source 166 according to yet other examples. The XYZ-coordinate triad shown in FIG. 8 has the same orientation as the XYZ-coordinate triad of FIG. 2 to indicate the spatial relationship between the views of FIGS. 2 and 8. In FIG. 8, the laser source 166 has the laser array 210 illustrated in FIG. 4. As described above in reference to FIG. 4, that laser array 210 has one hundred semiconductor lasers 402 arranged along the substrate 410 in a rectangular array. Attached to the laser array 210 is the FOV adapter 220 having ten thousand optical waveguides 224. As a consequence, the laser source 166 of FIG. 7 has a (one hundred)-to-one ratio of the optical waveguides 224 to the semiconductor lasers 402.

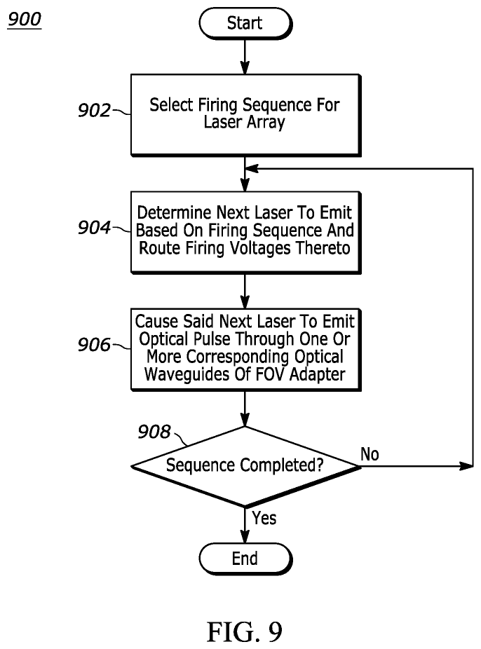

FIG. 9 is a flowchart illustrating an optical method 900 according to some examples. The method 900 can be implemented, e.g., using the controller 110, the memory 120, and the driver circuit 150, and the light source 166. The method 900 is described below in continued reference to FIGS. 1-8.

The method 900 includes the controller 110 retrieving from the memory 120 a firing or scan sequence (in block 902). When executed, a firing or scan sequence causes the light source 166 to emit a sequence of laser pulses to sequentially illuminate different portions of the FOV 298. The memory 120 may have stored therein a plurality of different firing or scan sequences. One of said different firing or scan sequences may be selected (in block 902) based on the intended application of the laser source 166 and/or specific instance thereof.

A firing or scan sequence may typically specify the order in which different semiconductor lasers 402 will emit pulses of light. For example, one possible firing or scan sequence may be in accordance with a raster pattern that effectively causes the optical-probe beam 172 to sweep across the FOV 298 horizontally and vertically at an approximately steady rate. With the laser array 210, the raster pattern can be implemented by (i) sequentially firing individual semiconductor lasers 402 of the first row, e.g., starting from the left end of the row and moving toward the opposite end of the row; (ii) sequentially firing individual semiconductor lasers 402 of the second row, e.g., starting from the right end of the row and moving toward the opposite end of the row, and so on until all individual semiconductor lasers 402 of the last row are sequenced through. Other suitable firing or scan sequences and patterns may also be used and controlled using the controller 110. In some such sequences, a first subset of two or more individual semiconductor lasers 402 may be fired at the (same) first time, and then a different second subset of two or more individual semiconductor lasers 402 may be fired at the (same) second time, and so on.

The method 900 includes the controller 110 selecting (in block 904) a next one of the semiconductor lasers 402 of the laser source 166 based on the firing or scan sequence loaded up in block 902. The address (e.g., the row number and the column number) of the selected semiconductor laser 402 is then used (in block 904) to generate an appropriate address-control signal 254. The address-control signal 254 so generated causes the one or more electrical signals 252 generated by the driver circuit 150 to be routed to the selected laser 402.

The method 900 includes the controller 110 and the driver circuit 150 causing the selected semiconductor laser 402 to emit an optical pulse, e.g., by causing an appropriate current to be injected into the selected semiconductor laser 402 (in block 906). Depending on the implementation, the emitted optical pulse will be in the form of one or more optical-probe beams 272 emitted from the corresponding one or more optical waveguides 224 (also see FIGS. 2-3). For example, for the implementation of the laser source 166 illustrated in FIG. 6, one optical-probe beam 272 will be emitted from the corresponding one of the optical waveguides 224. In contrast, for the implementation of the laser source 166 illustrated in FIG. 7, nine optical-probe beams 272 will be emitted from the corresponding nine optical waveguides 224. For the implementation of the laser source 166 illustrated in FIG. 8, one hundred optical-probe beams 272 will be emitted from the corresponding one hundred optical waveguides 224.

The method 900 includes the controller 110 determining (in decision block 908) whether or not the firing or scan sequence selected in block 902 is completed. When the controller 110 determines that the firing or scan sequence is not completed, the processing of the method 900 is looped back to the block 904. Otherwise, the processing of the method 900 is terminated.

The optical pulse emitted at the block 906 of the method 900 will propagate toward the corresponding object within the FOV 298, and the corresponding reflected optical pulse 180 will be received by the receiver 168. The time difference between the optical-pulse emission from the laser source 166 and the reflected-pulse arrival to the receiver 168, often referred to as the time of flight (TOF), can then be determined and converted into the depth information for the corresponding portion of the FOV 298. Therefore, by executing in full the firing or scan sequence selected at the block 902, a depth map of the FOV 298 is generated by the system 100.

It is to be understood that the above description is intended to be illustrative and not restrictive. Many implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed subject matter incorporate more features than are expressly recited in each claim. Rather, as the following claims reflect, inventive subject matter lies in fewer than all features of a single disclosed example. Thus, the following claims are hereby incorporated into the Detailed Description, with each claim standing on its own as a separately claimed subject matter.

While this disclosure includes references to illustrative examples, this specification is not intended to be construed in a limiting sense. For example, although various instances of the laser source 166 are describe above in reference to the lidar system 100, the invention(s) disclosed herein are not so limited. For example, at least some instances of the laser source 166 can also be used for various “structured light” measurements. Various modifications of the described aspects, features, and examples are possible.

Herein, the term “structured light” refers to a 3D sensing technique in which the scene (e.g., 198) is illuminated with a specially designed 2D spatially varying intensity pattern, e.g., a pattern of spots generated by a suitable light source (e.g., 166). An imaging sensor (e.g., 168) is used to acquire a 2D image of the scene under the structured-light illumination. When the scene is a planar surface without any 3D surface variations, the pattern in the acquired image is undistorted and is similar to the projected structured-light pattern. However, when the surface in the scene is nonplanar, the geometric shape of the surface distorts the projected structured-light pattern for the imaging sensor. A suitable structured-light image-processing algorithm (e.g., run by 110, 120) can then be used to extract the 3D surface shape based on the detected distortion of the projected structured-light pattern.

Unless explicitly stated otherwise, each numerical value and range should be interpreted as being approximate as if the word “about” or “approximately” preceded the value or range.

The use of figure numbers and/or figure reference labels (if any) in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus, comprising:
an array of lasers disposed along a substantially planar substrate; and
an optical adapter having a first surface and an opposite second surface, the first surface being adjacent and along the array of lasers;
wherein the optical adapter includes a plurality of optical waveguides, each of the optical waveguides having a respective first end at the first surface and a respective second end at the second surface, the plurality of optical waveguides being optically end-connected to the array of lasers;
wherein an end section of a first optical waveguide of the plurality of optical waveguides is oriented at a first nonzero angle with respect to a surface normal of the second surface, said end section of the first optical waveguide being adjacent to the respective second end thereof; and
wherein an end section of a second optical waveguide of the plurality of optical waveguides is oriented at a different second nonzero angle with respect to the surface normal, said end section of the second optical waveguide being adjacent to the respective second end thereof.

2. The apparatus of claim 1, wherein an end section of a third optical waveguide of the plurality of optical waveguides adjacent to the respective second end thereof is orthogonal to the second surface.

3. The apparatus of claim 2, wherein at least one of the first and second optical waveguides is closer to a nearest perimeter portion of the optical adapter than the third optical waveguide.

4. The apparatus of claim 2, wherein at least one of the first and second optical waveguides is farther from a nearest perimeter portion of the optical adapter than the third optical waveguide.

5. The apparatus of claim 1, wherein an end section of at least a third optical waveguide of the plurality of optical waveguides adjacent to the respective second end thereof is oriented at a third nonzero angle with respect to the surface normal, the third nonzero angle being larger than the first nonzero angle and being smaller than the different second nonzero angle.

6. The apparatus of claim 1, wherein each of the optical waveguides comprises a respective optical fiber.

7. The apparatus of claim 6, wherein the respective optical fibers are fixedly attached to each other to form a monolithic structure of the optical adapter.

8. The apparatus of claim 6, wherein at least some of the respective optical fibers are tapered.

9. The apparatus of claim 1, wherein the optical waveguides are arranged in the optical adapter such that each of the lasers is configured to emit light through a respective single one of the optical waveguides.

10. The apparatus of claim 1, wherein the optical waveguides are arranged in the optical adapter such that each of the lasers emits light through a respective set of the optical waveguides, each of the respective sets having an equal fixed number of the optical waveguides, the equal fixed number being in a range from 2 to 100.

11. The apparatus of claim 1, wherein the first surface of the optical adapter has a smaller surface area than the opposite second surface.

12. The apparatus of claim 1, wherein individual ones of the lasers are individually addressable to emit light.

13. The apparatus of claim 12, further comprising circuitry to cause different subarrays of the array of lasers to emit respective optical pulses at different respective times.

14. The apparatus of claim 12, further comprising circuitry to cause different ones of the lasers to emit respective optical pulses at different respective times.

15. The apparatus of claim 1, wherein each of the lasers comprises a respective vertical cavity surface-emitting laser.

16. The apparatus of claim 1, further comprising an optical receiver configured to receive reflected light from a field of view of the optical adapter, the reflected light being produced by reflections, from one or more objects in the field of view, of light emitted by the array of lasers through the optical adapter.

17. The apparatus of claim 16, further comprising circuitry to perform time-of-flight measurements based on timing of the reflected light received by the optical receiver.

18. The apparatus of claim 1, wherein the optical waveguides are arranged in the optical adapter such that:
a first portion of a field of view of the optical adapter has a first average density of optical beams emitted through the optical adapter; and
a second portion of the field of view has a different second average density of optical beams emitted through the optical adapter.

19. The apparatus of claim 1, wherein the array of lasers has at least ten lasers.

20. An optical method, comprising:
determining, via an electronic controller, a next laser to emit light in an array of lasers;
routing, via a driver circuit, one or more firing voltages to the next laser to cause the next laser to emit an optical pulse through a respective set of one or more optical waveguides of an optical adapter having a first surface and an opposite second surface, the first surface being adjacent and along the array of lasers; and
repeating said determining and said routing to cause different ones of the lasers in the array of lasers to emit respective optical pulses at different respective times;
wherein the optical adapter includes a plurality of the optical waveguides, each of the optical waveguides having a respective first end at the first surface of the optical adapter and a respective second end at the second surface of the optical adapter, the plurality of optical waveguides being optically end-connected to the array of lasers;
wherein an end section of a first optical waveguide of the plurality of optical waveguides is oriented at a first nonzero angle with respect to a surface normal of the second surface, said end section of the first optical waveguide being adjacent to the respective second end thereof; and
wherein an end section of a second optical waveguide of the plurality of optical waveguides is oriented at a different second nonzero angle with respect to the surface normal, said end section of the second optical waveguide being adjacent to the respective second end thereof.
